(19) United States
(12) Patent Application Publication
(10) Pub. No.: US 2026/0048933 A1
(43) Pub. Date: Feb. 19, 2026

(54) Trash Can Extender Apparatus

(71) Applicant: Cynthia R Turner, Greenville, SC (US)

(72) Inventor: Cynthia R Turner, Greenville, SC (US)

(21) Appl. No.: 19/058,594

(22) Filed: Feb. 20, 2025

Related U.S. Application Data
(60) Provisional application No. 63/682,714, filed on Aug. 13, 2024.

(51) Int. Cl. B65F 1/14

(52) U.S. Cl. CPC B65F 1/1415; B65F 2220/106

(57) ABSTRACT

The present invention relates to a trash can extender apparatus that may be used to increase the storage capacity of a trash can. In one embodiment the extender apparatus may be secured to an interior or exterior surface of a trash can and has an extended position and a collapsed position. In the extended position, where a frame is extended upwardly from a refuse opening defined in the trash can, the extender apparatus extends the height of the trash can and increases the storage volume of the trash can. The extender apparatus also has a closed position where the frame is lowered to a point that is approximately flush with the lip of the trash can so that the lid may close and cover the refuse opening.

### TECHNICAL FIELD OF INVENTION

The present invention relates to a trash can extending assembly that may be installed on an outdoor trash can such as the type that is typically provided by a municipality and/or commercial trash service. The present invention allows the volume of the trash can to be increased by extending the top of the trash can by way of an extendable and retractable apparatus that can increase the height of the trash can and/or extend the width of the trash can's refuse opening into which debris may be placed. When not in use, the extender may be retracted, thus allowing the trash can lid to secure and/or cover the refuse opening.

### BACKGROUND OF INVENTION

Oftentimes users of trash cans have debris to be discarded that will not fit in the trash can available for use. Whether the issue is a single item that is too large to fit within the trash can or multiple items that will not fit within the storage volume provided by the trash can, there are times where the user simply has more debris than the trash can is capable of containing. In response, users often place the excess debris next to the trash can, hoping that the trash service will remove the excess debris. But the excess debris is not always removed. In some jurisdictions, there are regulations restricting the user's ability to simply place excess debris anywhere but in the trash can when taking the trash to the street for pick up. Moreover, there may be additional fees charged for removal of the excess debris as well as environmental hazards resulting from the trash being scattered or otherwise left on the side of the road.

It would, therefore, be advantageous if users had a trash can extender apparatus that could be retrofit to the trash can and that allowed the user to temporarily increase the storage volume of their trash can so as to accommodate the excess volume of debris and/or pieces of debris that are too large to fit into the trash can without protruding from out of the trash can's refuse opening.

It would further be advantageous if the trash can extender apparatus could have an extended position that increases the volume of the trash can and a collapsed position that allows the lid of the trash can to secure and/or cover the refuse opening without the need to remove the extender from the trash can.

It would also be advantageous if the extender apparatus included a means of enclosing the refuse opening so that the debris is completely enclosed within the interior cavity created by the extender apparatus.

It would also be advantageous if the extender apparatus included a locking mechanism to maintain the apparatus in the extended position until such time that the user desired to place the extender apparatus in a collapsed position.

### SUMMARY OF INVENTION

In one embodiment, the present invention comprises a trash can extender apparatus comprising a securing frame that is carried by the trash can and is adapted to fit within a refuse opening defined by the trash can and is disposed adjacent to an interior surface of the trash can; an extension frame having an extension arm that is slidably connected to the securing frame and interconnects the extension frame to the securing frame, wherein the extension frame has an extended position where the extension arm extends upwardly from the securing frame so that the extension frame is vertically spaced from the securing frame and wherein the extension frame has a collapsed position where the extension arm retracts towards the bottom of the trash can so that the extension frame is placed adjacent to the securing frame; and a flexible barrier that is carried by the extension frame so that when the extension frame is in the extended position, the flexible barrier forms a conduit extending upwardly from the refuse opening to the extension frame, thereby increasing a storage volume of the trash can so that debris may be stored above the refuse opening.

In one embodiment, the trash can extender further comprises a locking mechanism that is adapted to engage the extension arm so as maintain the extension arm in an upwardly extended position, thereby maintaining the extension frame in the extended position. The locking mechanism may be biased and adapted to engage one of a notch, a flange, a lip and a protuberance formed the extension arm.

In one embodiment, the extension frame is adapted to fit within the perimeter of a lid of the trash can so that when the extension frame is in the collapsed position and the lid is in a closed position, the extension frame is disposed between the lid and a lip of the refuse opening so that the lid may cover the refuse opening.

In one embodiment, the trash can extender further comprises a securing member that is carried by the securing frame that is adapted to engage a lip of the refuse opening and secure the securing frame to the trash can.

In one embodiment, the flexible barrier has a first end that is carried along the perimeter of the extension frame and a second end that is carried by at least a portion of the securing frame. The flexible barrier may comprise one of a netting, a mesh and a fabric.

In one embodiment, the extension arm includes a flange that is adapted to be engaged by the securing frame so as to slidably connect the extension arm to the securing frame.

In another embodiment of the present invention comprises a trash can extender that may be installed on a trash can so that the extender is carried by the portion of the trash can that defines the refuse opening, wherein the trash can extender comprises a plurality of extension bands, each having a frustoconical shape such that each band has a lower edge that defines a lower opening having a first diameter and a first circumference/perimeter and an upper edge that defines an upper opening having a second diameter and a second circumference/perimeter. In at least one embodiment, the diameter, circumference and/or perimeter of the upper opening defined by the upper edge is greater than the diameter, circumference and/or perimeter of the lower opening defined by the lower edge. In one embodiment, each of the extension bands has a plurality of lower edges that define a lower opening and a plurality of upper edges that define an upper opening. In such an embodiment, a first distance d1 separates two opposing lower edges and a second distance d2 separates two opposing upper edges. In such an embodiment the first distance d1 is less than the second distance d2.

In either embodiment, when the first outer extension band of the plurality of extension bands is moved upwards from the refuse opening, the lower edge of the first extension band engages the upper edge of a second, adjacent extension band, thus causing the adjacent extension band to move upwardly from the refuse opening. As the second extension band moves upwards, the lower edge of the second extension band engages an upper edge of a third extension band, thus causing the third extension band to move upwardly from the refuse opening. In one embodiment, the plurality of extension bands is secured to an exterior surface of a trash can at a location that is adjacent to a refuse opening defined in the trash can so that when the upper edge of a fourth extension band is engaged by the lower edge of the third extension band, the vertical distance that the fourth extension band may move is restricted.

In one embodiment, the trash can extender apparatus has an extended position where the extension bands are pulled upwardly from the refuse opening, thereby creating an interior cavity extending from the refuse opening to the upper edge of the first extension band in which refuse may be stored.

In one embodiment, the present invention comprises a securing frame that is carried by the trash can and is disposed adjacent to an interior surface of the trash can; an extension arm that is slidably carried by the securing frame and interconnects the securing frame to an extension frame; and a mesh that is carried by the extension frame and extends from the extension frame to a refuse opening defined by the trash can so that when the extension arm extends upwardly from the securing frame, the extender apparatus is placed in an extended position and the mesh forms an interior cavity extending from the refuse opening to the extension frame, thereby increasing a storage volume in which debris may be stored.

In at least one embodiment, the trash can extender apparatus includes a locking mechanism that engages the extension arm to maintain the extender apparatus in the extended position until the lock is disengaged.

In at least one embodiment, the extender apparatus has a collapsed position whereby the extension frame and/or the extension bands are placed in a position that allows the lid of the trash can to be closed so that it may secure and/or cover the refuse opening.

In at least one embodiment the extender apparatus includes a top that may cover the opening defined by extension frame and enclose the cavity created by the mesh.

### BRIEF DESCRIPTION OF THE DRAWINGS

FIG. 1 is a perspective view of an embodiment of the invention wherein the extender is in a collapsed position;

FIG. 2 is a perspective view of an embodiment of the invention wherein the extender is in a collapsed position;

FIG. 3 is a perspective view of an embodiment of the invention wherein the extender is in an extended position;

FIG. 4 is a perspective view of an embodiment of the invention wherein the extender is in an extended position;

FIG. 5 is a perspective view of an embodiment of the invention wherein the extender is in an extended position;

FIG. 6 is a perspective view of an embodiment of the invention wherein the extender is in an extended position;

FIG. 7a is a perspective view of an embodiment of the invention wherein the extender is in a collapsed position;

FIG. 7b is a perspective view of an embodiment of the invention wherein the extender is in a collapsed position with the lid of the trashcan being in a nearly closed position;

FIG. 8 is a perspective view of a portion of the extension arm of an embodiment of the invention, showing the locking mechanism in a locked position; and

FIG. 9 is a perspective view of a portion of the extension arm of an embodiment of the invention, showing the locking mechanism in an unlocked position.

### DETAILED DESCRIPTION OF PREFERRED EMBODIMENTS OF INVENTION

With reference to the drawings, the invention will now be described in more detail.

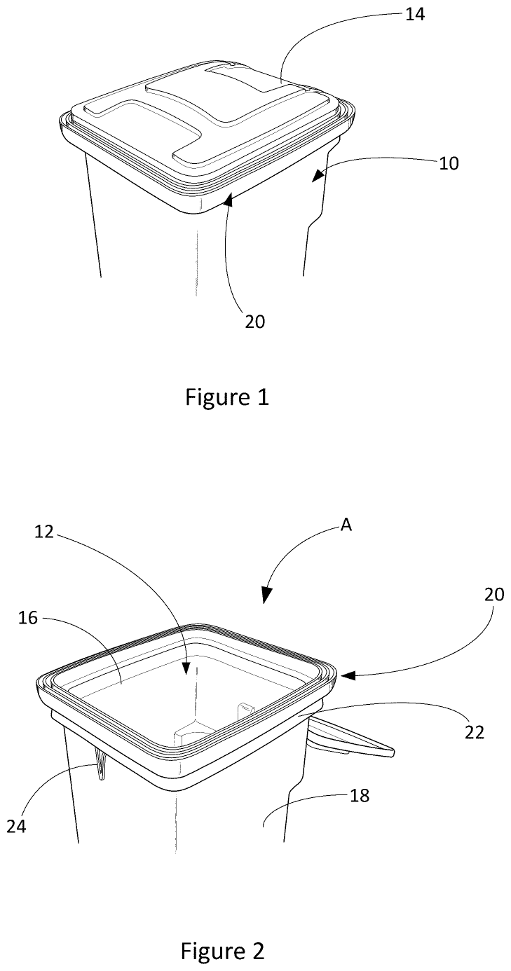

Referring now to FIGS. 1-4, a first embodiment of the invention will be more clearly described. The present invention may be used with any number of different trash cans, each having different shapes, sizes and features but each defining a refuse opening into which debris can be deposited. In the shown embodiment, the present invention is installed on a trash can 10 that defines a refuse opening 12 and having a lid 14 that secures and/or covers the refuse opening. In this embodiment, the extender apparatus 20 is attached to the trash can so that the apparatus is carried adjacent to the refuse opening 12. In at least one embodiment, the extender apparatus may be disposed adjacent to the interior surface 16 of the trash can. In other embodiments, the extender apparatus may be carried by and/or disposed adjacent to the exterior surface 18 of the trash can. In the embodiment shown in FIGS. 1-4, the extender apparatus 20 is secured to the exterior surface 18 of the trash can so that the extender apparatus is disposed adjacent to the mouth of the refuse opening 12. The apparatus may be secured to the trash can by way of a flexible sleeve 22 that may be fitted around the circumference of the trash can (preferably at the lip 17 that defines the refuse opening 12) and tightened by way of a drawstring 24. In alternate embodiments, the extender apparatus could be secured to the trash can by way of clips, clamps, hooks, screws, detents, hook and loop fasteners or other fasteners generally known in the art. Similarly, the sleeve could be elastic, thus alleviating the need for the drawstring.

In the shown embodiment, the extender apparatus includes 5 concentric extension bands 26, 28, 30, 32 and 34. Each concentric band may be made of a rigid material such as plastic or metal or a malleable material such as rubber or silicone. Each of the extension bands should have a cross-sectional shape that corresponds to the shape and dimensions of the refuse opening of the trash can on which it is being installed. For example, each of the concentric bands could have a circular cross-sectional shape to fit on a trash can having a circular refuse opening. Alternatively, the concentric bands could have a cross-sectional shape that is generally square, rectangular or any other shape corresponding to a refuse opening on a trash can. In the shown embodiment, the concentric bands have a cross-sectional shape that is square. In the shown embodiment, each of the concentric bands have a frustoconical, tapered and/or conical shape such that each band includes a lower edge 26a, 28a, 30a, 32a and 34a defining a lower opening having a first diameter d1 (and/or a distance d1 that separates at least two of the opposing lower edges) and further including an upper edge 26b, 28b, 30b, 32b and 34b defining an upper opening having a second diameter d2 (and/or a distance d2 that separates at least two of the opposing upper edges). In at least one embodiment, for each band, the lower distance/diameter d1 is smaller than the upper distance/diameter d2. In at least one embodiment the circumference and/or perimeter of the opening defined by the upper edges is greater than the circumference and/or perimeter of the opening defined by the lower edges.

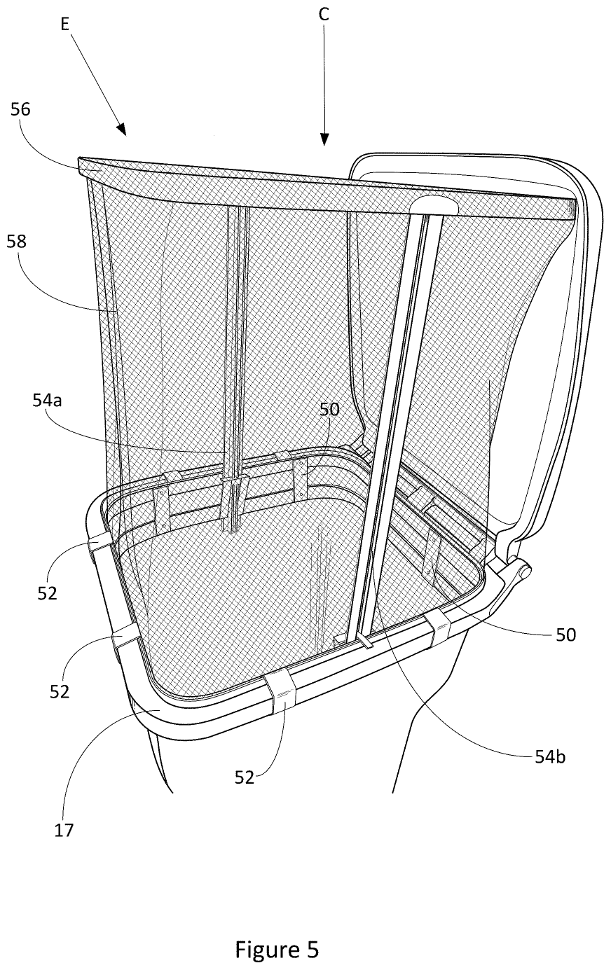

The lower most extension band 34 has lower circumference/perimeter/distance/diameter d1 that is slightly larger than the dimensions of the refuse opening. The first concentric band 34 has an upper distance/diameter d2 that is slightly larger than the lower distance/diameter d3 of the second concentric band 32. The upper distance/diameter d4 of the second concentric extension band 32 is slightly larger than the lower distance/diameter d5 of the third concentric ring. This pattern could continue for as many concentric bands as is desired for the extender apparatus. When the upper most concentric band (shown as 26 in FIG. 4 or as 30 in FIG. 5) is pulled upward, its lower edge 26a will contact the upper edge 28b of concentric band 28. As the lower edge 26a contacts the upper edge 28b, concentric band 28 will be pulled upward so that its lower edge 28a will contact the upper edge 30b of concentric band 30. As the lower edge lower edge 28a contacts the upper edge 30b, concentric band 30 will be pulled upward so that its lower edge 30a contacts the upper edge 32b, thus pulling concentric band 32 upwards. As concentric band 32 is pulled upwards, its lower edge 32a will contact the upper edge 34a of the lower most concentric band 34, which is secured to the outer surface 18 of the trash can via the sleeve 22 and drawstring 24.

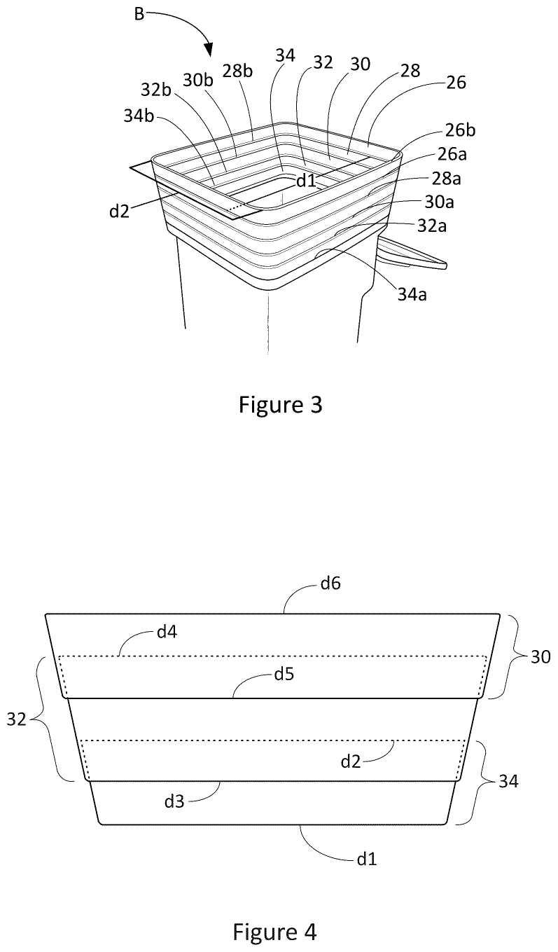

When the upper most band 26 is pulled upwards with sufficient force, the respective edges of the bands will create enough friction that the extender apparatus 20 may remain in the extended position shown as B in FIG. 3. To place the extender apparatus in a collapsed position, the user need only push down on the upper most extension band 26 with a force that is sufficient to overcome the frictional force between the respective extension bands 26, 28,30, 32 and 34. Once that frictional force is overcome, gravity will pull the bands into a collapsed position, shown as A in FIG. 2.

When in an extended position, the extender apparatus increases the height of the trash can, thus increasing the trash can's storage capacity. Due to the tapered shape of the extension bands, the extension apparatus creates a flared opening that increases the distance/diameter/circumference/perimeter of the trash can's refuse opening. In at least one embodiment, distance/diameter/circumference/perimeter of the trash can's refuse opening increases proportionately with the increase in the trash can's height when the extension apparatus is in an extended position.

In one embodiment, the extension apparatus could further include a cover that is adapted to cover the opening created by the uppermost extension band 26. In such an embodiment, the cover could include a screen or flexible mesh that is removably or integrally connected to the upper most extension band. Such a cover could further include snaps, zippers, buttons or other fasteners to secure the cover in a closed position when secured to the uppermost extension band 26.

When in a collapsed position, each of the lower extension bands 28, 30, 32 and 34 will be housed within the upper most extension band 26 and the upper edge 26b of the extension band 26 shall be adjacent to and/or flush with the mouth of the refuse opening 12 so that the trash can lid 14 is capable of closing to secure and/or cover the refuse opening when the extender apparatus is in a collapsed position.

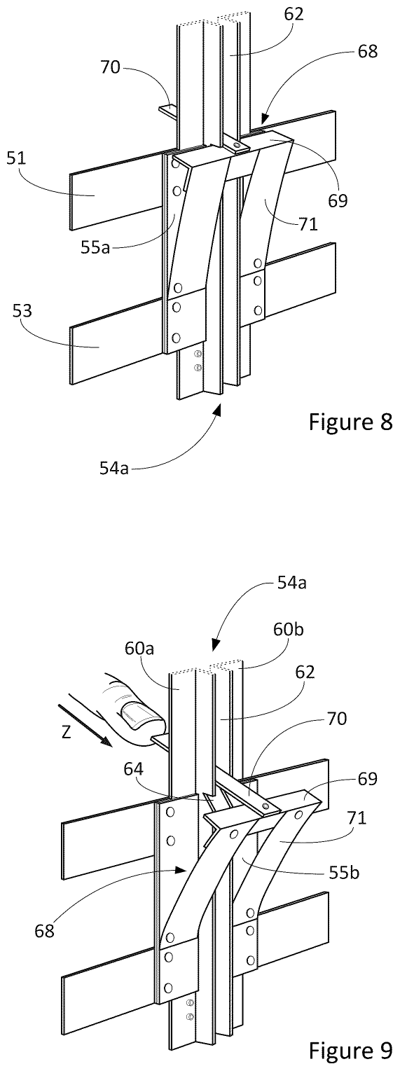

Referring now to FIGS. 5-10, a second embodiment of the present invention will be described.

In the shown embodiment, the extender apparatus comprises a securing frame 50 that is disposed adjacent to the interior surface 16 of the trash can at a location that is adjacent to the mouth of the refuse opening 12. In the shown embodiment the securing frame includes a first, upper rail perspective view of an embodiment of the invention wherein the extender is in a collapsed position 51 that is adapted to sit adjacent to and/or substantially against the trash can's interior surface 16 and at a point where the upper rail is substantially flush with the lip 17 that defines the mouth of the refuse opening. The securing frame further includes a second lower rail 53 that is adapted to sit adjacent to and/or substantially against the trash can's interior surface 16 and at a point that is beneath the upper rail 51 and thus closer to the base of the trashcan. The use of two vertically spaced rails provides increased stability and reduces movement of the securing frame within the refuse opening. In the shown embodiment the upper rail 51 is connected to the lower rail 53 by a plurality of cross bars 55a-b. In at least one embodiment the circumference of the upper rail is substantially equal to the circumference of the lower rails. In alternate embodiment, the circumference of the upper rail could be greater or less than the circumference of the bottom rail. In alternate embodiments, the securing frame may consist solely of a single rail. In such an embodiment, a wider rail may be preferred.

In the shown embodiment, the securing frame 50 is carried by a plurality of J hooks 52 that wrap over or otherwise engage the lip 17 of the refuse opening so that the securing frame sits flush against the interior surface 16. In alternate embodiments, fasteners generally known would suffice. The extender apparatus further includes two extension arms 54a & 54b that are slidably carried by the securing frame and interconnect the securing frame to an extension frame 56. When in the extended position (E), the extension arms slide a first direction that is upwardly from the securing frame 50 and the mouth of the refuse opening 12 to support and maintain the extension frame 56 in a position that is vertically spaced by a first distance from the securing frame and the mouth of the refuse opening. When in this extended position (E) the extension frame carries a first end of flexible barrier 58, which extends around all or substantially all of the perimeter (P) of the extension frame so that the flexible fabric creates a conduit having an interior cavity C. A second end of the flexible fabric is attached to at least a portion of the securing frame so that the conduit and/or interior cavity extends from the extension frame to the securing frame. When the extension frame is in the extended position, the conduit increases the storage volume of the trash can by allowing debris to be stored within the interior cavity at a location that is above the refuse opening. In this extended position, the apparatus virtually extends the trash can by creating a flexible conduit that extends from the refuse opening to the extension frame that is vertically spaced from the refuse opening. In one embodiment, the flexible barrier comprises a netting, a mesh, a fabric (whether made of synthetic or natural materials) but any other material designed to keep refuse inside interior cavity C could be used.

The extension frame 56 may also be placed in a collapsed position (D) where the extension arms 54a-b retract in a second direction that is towards the base of the trash can. When in the collapsed position, the extension frame is placed adjacent to the securing frame so that it is vertically spaced by a second distance from the securing frame and refuse opening. In some embodiments, the second distance is zero in other embodiments, the second distance is less than the first distance by which the extension frame is vertically spaced from the securing frame when in an extended position (E).

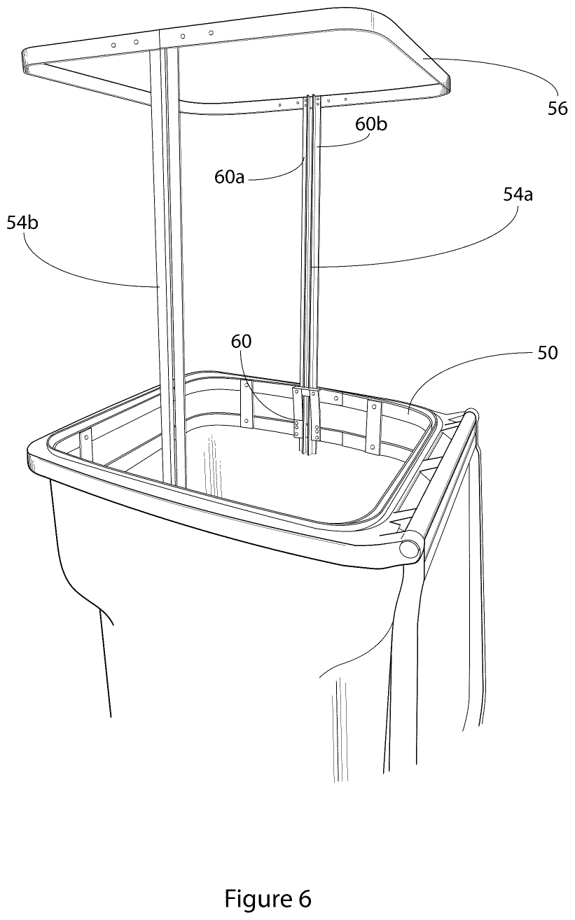

As can be seen more clearly in FIGS. 6, 8-9, the extension arms 54a-b include opposing side flanges 60a & 60b that protrude laterally from a central track and/or rail 64 that runs along the length of the extension arm 54. The flanges 60a-b are received by a securing channel 66 that is adapted to keep the portion of the extension arm that is in the securing channel adjacent to the securing frame, thereby maintain the stability of extension arm. The securing frame further includes biased locking member 68 that engages the track 62. In the shown embodiment, the locking member is carried by the securing channel. As the extension arms 54a-b are raised, the lock 68 engages a stop 64 that is notched into the track. In one embodiment, the lock 68 includes a locking crossbar member 69 that is carried by a biased arm 71 that maintains a force that pushes the locking crossbar member 69 towards the track 62. When the extension arms are raised to a sufficient height, the biased arm 71 will cause the crossbar 69 to engage the stop 64 such that the extension arm may not be lowered until a force is applied to the unlocking member 70 in direction Z, at which point the crossbar disengages the stop so that the extension arm 54a may be lowered. In alternate embodiments, the lock could engage a notch, flange, lip or other protuberance disposed on or defined in the track. Once lock 68 engages the stop 64, the extension arms may not be lowered into a collapsed position (D). In the embodiment shown in FIG. 10, the lock may be provided with an unlocking member 70 that when pressed inwards towards the extension arm 54a and/or the frames upper rail 501, will move the biased lock away from the notch, thus, disengaging lock from the stop and allowing the extension arms to be lowered into a collapsed position (D). In alternate embodiments, the locking member could be a screw, detent, button or any other locking means that are generally known in the art.

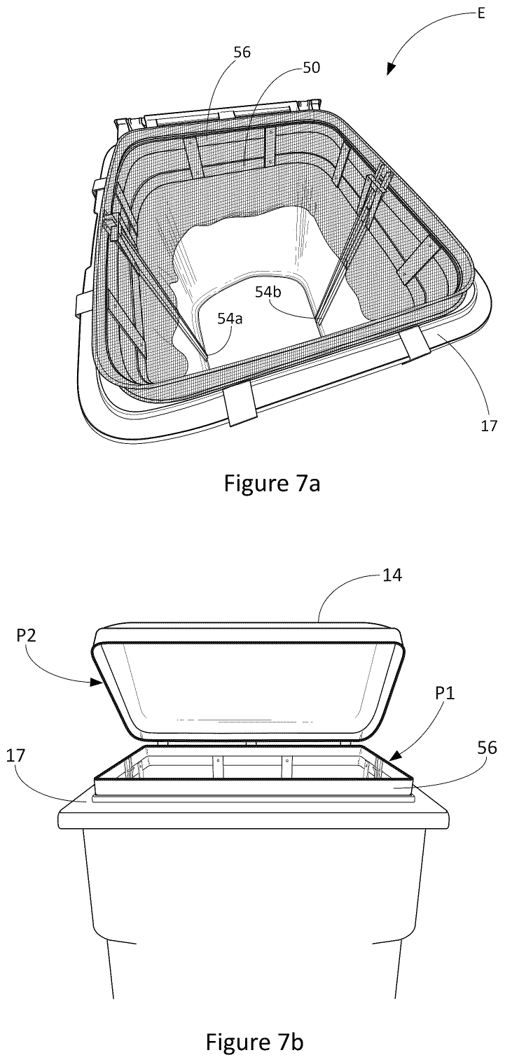

As shown in FIGS. 7a-b, when in a collapsed position D, the extension frame 56 sits flush with or just above the lip 17 of the trash can, such that the lid may be fully closed over the refuse opening 12. The extension frame is adapted so that its perimeter P1 may fit within the perimeter P2 of the trash can's lid so that when the extension frame is in the collapsed position and the lid is in a closed position, the extension frame is disposed between the lid 14 and the upper surface of the trash can that forms the lip 17 of the refuse opening so that the lid may cover the refuse opening. In at least one embodiment, when the extension frame is in the collapsed position and the lid is in a closed position, the extension frame is disposed completely below the lid and at least a portion of the extension frame is disposed above the refuse opening.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A trash can extender apparatus comprising:
A securing frame that is carried by the trash can and is adapted to fit within a refuse opening defined by the trash can and is disposed adjacent to an interior surface of the trash can;
An extension frame having an extension arm that is slidably connected to the securing frame and interconnects the extension frame to the securing frame, wherein the extension frame has an extended position where the extension arm extends upwardly from the securing frame so that the extension frame is vertically spaced from the securing frame and wherein the extension frame has a collapsed position where the extension arm retracts towards the bottom of the trash can so that the extension frame is placed adjacent to the securing frame; and
A flexible barrier that is carried by the extension frame so that when the extension frame is in the extended position, the flexible barrier forms a conduit extending upwardly from the refuse opening to the extension frame, thereby increasing a storage volume of the trash can so that debris may be stored above the refuse opening.

2. The trash can extender apparatus of claim 1 further comprising a locking mechanism that is adapted to engage the extension arm so as maintain the extension arm in an upwardly extended position, thereby maintaining the extension frame in the extended position.

3. The trash can extender apparatus of claim 2 wherein the locking mechanism is biased and adapted to engage one of a notch, a flange, a lip and a protuberance formed the extension arm.

4. The trash can extender apparatus of claim 1 wherein the extension frame is adapted to fit within the perimeter of a lid of the trash can so that when the extension frame is in the collapsed position and the lid is in a closed position, the extension frame is disposed between the lid and a lip of the refuse opening so that the lid may cover the refuse opening.

5. The trash can extender apparatus of claim 1 further comprising a securing member that is carried by the securing frame that is adapted to engage a lip of the refuse opening and secure the securing frame to the trash can.

6. The trash can extender apparatus of claim 1 wherein the flexible barrier has a first end that is carried along the perimeter of the extension frame and a second end that is carried by at least a portion of the securing frame.

7. The trash can extender apparatus of claim 1 wherein the flexible barrier comprises one of a netting, a mesh and a fabric.

8. The trash can extender apparatus of claim 1 wherein the extension arm includes a flange that is adapted to be engaged by the securing frame so as to slidably connect the extension arm to the securing frame.

9. A trash can extender apparatus comprising:
A securing frame that is carried by the trash can and disposed adjacent to an interior surface of the trash can;
An extension frame having an extension arm that is slidably connected to the securing frame and interconnects the extension frame to the securing frame, wherein the extension frame has an extended position where the extension arm moves in a first direction so that the extension frame is spaced from a refuse opening defined in the trash can and wherein the extension frame has a collapsed position where the extension arm moves in a second direction so that the extension frame is placed adjacent to the refuse opening; and
A flexible barrier that is carried by the extension frame so that when the extension frame is in the extended position, the flexible barrier forms an interior cavity that extends upwardly from the refuse opening to the extension frame, thereby increasing a storage volume of the trash can in which debris may be stored.

10. The trash can extender apparatus of claim 9 further comprising a locking mechanism that is adapted to engage the extension arm, thereby maintaining the extension frame in the extended position.

11. The trash can extender apparatus of claim 10 wherein the locking mechanism is biased and adapted to engage one of a notch, a flange, a lip and a protuberance formed the extension arm.

12. The trash can extender apparatus of claim 9 wherein the extension frame is adapted to fit within the perimeter of a lid of the trash can so that when the extension frame is in the collapsed position and the lid is in a closed position, the extension frame is disposed between the lid and an upper surface of the trash can that defines the refuse opening.

13. The trash can extender apparatus of claim 9 further comprising a securing member that is carried by the securing frame that is adapted to engage a surface of the trash can, thereby securing the securing frame to the trash can.

14. The trash can extender apparatus of claim 9 wherein the flexible barrier has a first end that is carried along the perimeter of the extension frame and a second end that is carried by at least a portion of the securing frame.

15. The trash can extender apparatus of claim 9 wherein the flexible barrier comprises one of a netting, a mesh and a fabric.

16. The trash can extender apparatus of claim 9 wherein the extension arm includes a flange that is adapted to be engaged by the securing frame so as to slidably connect the extension arm to the securing frame.

17. A trash can extender apparatus comprising:
A securing frame that is carried by the trash can a refuse opening defined in the trash can;
An extension frame having an extension arm that is carried by the securing frame and interconnects the extension frame to the securing frame, wherein the extension frame has an extended position where the extension arm maintains the extension frame in a position that is vertically spaced from the securing frame by a first distance and wherein the extension frame has a collapsed position where the extension frame is vertically spaced from the securing frame by a second distance, wherein the second distance is less than the first distance; and
A flexible barrier that is carried by the extension frame that forms an interior cavity extending from the securing frame to the extension frame, thereby increasing a storage volume of the trash can in which debris may be stored.

18. The trash can extender apparatus of claim 17 wherein the extension frame is adapted to fit within the perimeter of a lid of the trash can so that when the extension frame is in the collapsed position and the lid is in a closed position, the extension frame is disposed completely below the lid and at least a portion of the extension frame is disposed above the refuse opening.

19. The trash can extender apparatus of claim 18 wherein the flexible barrier has a first end that is carried along the perimeter of the extension frame and a second end that is carried by at least a portion of the securing frame.

20. The trash can extender apparatus of claim 19 wherein the flexible barrier comprises one of a netting, a mesh and a fabric.
